(19) United States
(12) Patent Application Publication
(10) Pub. No.: US 2023/0357547 A1
(43) Pub. Date: Nov. 9, 2023

(54) Foamable composition of polymers comprising a branched copolymer containing polyamide blocks and polyether blocks

(71) Applicant: ARKEMA FRANCE, Colombes (FR)

(72) Inventors: Blandine TESTUD, Serquigny (FR); Sébastien QUINEBECHE, Serquigny (FR); Chao-Ting CHANG, Taipei (TW); Clio COCQUET, Colombes Cedex (FR)

(73) Assignee: ARKEMA FRANCE, Colombes (FR)

(21) Appl. No.: 18/245,201

(22) PCT Filed: Sep. 15, 2021
(86) PCT No.: PCT/FR2021/051578

§ 371 Date: Mar. 14, 2023

(30) Foreign Application Priority Data
Sep. 15, 2020 (FR) FR2009342

(51) Int. Cl. C08L 23/08; C08G 81/00; C08L 77/00; C08L 71/00; C08K 5/14; C08J 9/00; C08J 9/10

(52) U.S. Cl. CPC C08L 23/0853; C08L 23/0869; C08G 81/00; C08L 77/00; C08L 71/00; C08K 5/14; C08J 9/0061; C08J 9/103; C08L 2207/04; C08L 2205/03; C08L 2203/14; C08L 2203/30; C08J 2201/026; C08J 2203/04; C08J 2323/08; C08J 2471/02; C08J 2477/00

(57) ABSTRACT

The present invention relates to a foamable composition comprising an ethylene-vinyl acetate (EVA) copolymer and for a copolymer of ethylene and of alkyl (meth)acrylate and a branched copolymer containing polyamide blocks and polyether blocks, to a process for producing said composition and to the use of said composition. The present invention also relates to a foam, to a process for producing said foam and to the use of said foam.

### FIELD OF THE INVENTION

The present invention relates to a foamable composition comprising an ethylene-vinyl acetate (EVA) copolymer and/or a copolymer of ethylene and of alkyl (meth)acrylate and a branched copolymer containing polyamide blocks and polyether blocks, to a process for producing said composition and to the use of said composition. The present invention also relates to a foam, to a process for producing said foam and to the use of said foam.

### TECHNICAL BACKGROUND

Various foams based on EVA copolymers are used notably in the field of sports equipment, such as soles or sole components, gloves, rackets or golf balls, personal protection items in particular for practising sports (jackets, interior parts of helmets, shells, etc.). Such applications require a set of particular physical properties which ensure rebound capacity, a low compression set and a capacity for enduring repeated impacts without becoming deformed and for returning to the initial shape.

There are a large number of crosslinked EVA foams developed with chemical a foaming agents for applications in shoes. However, these EVA foams have limitations in term of flexibility, resilience, relatively narrow working temperature range, and also relatively low drawability, and durability that is not ideal. In addition, these foams suffer from a great deal of shrinkage regardless of the process used to obtain them.

The document WO 2013/192581 describes an EVA foam comprising a polyolefin elastomer and an olefin block copolymer.

The document US2017/0267849 describes a pre-foam composition comprising a partially hydrogenated thermoplastic elastomeric block copolymer, an olefin block copolymer and an EVA. The partially hydrogenated thermoplastic elastomeric block copolymer is an A-B-A or A-B copolymer in which the A block comprises the styrene units and the B block is a random copolymer of ethylene and olefin.

However, R proves difficult to obtain a foam which combines the properties of a low density and good resilience. This is because, in general, an improvement of the mechanical properties is observed accompanying an increase in the density, or, vice versa, a reduction in density negatively affects the mechanical properties, in particular the resilience.

There is a need to provide compositions which make it possible to obtain lighter polymer foams having reduced shrinkage after shaping of the foam, and having a better resilience while at the same time retaining good stiffness.

### SUMMARY OF THE INVENTION

The invention relates first to a composition comprising:
a copolymer (a) chosen from an ethylene-vinyl acetate (EVA) copolymer, a copolymer of ethylene and of alkyl (meth)acrylate and/or mixtures thereof,
a branched copolymer (b) containing polyamide blocks and polyether blocks (branched PEBA copolymer),
a crosslinking agent, preferably a peroxide.

According to one embodiment, the polymer composition according to the invention comprises from 30% to 99.9%, typically from 50% to 99.9%, preferably from 60% to 99.9%, more preferentially from 70% to 99.9%, by weight of the copolymer (a) relative to the total weight of the composition.

According to one embodiment, the composition comprises from 0.1% to 50%, preferably from 0.1% to 40%, by weight of the branched PEBA copolymer, relative to the total weight of the composition. Preferably, the composition comprises from 0.1% to 30%, or from 0.5% to 30%, or from 1% to 25%, or from 1% to 20%, by weight of the PEBA copolymer (b), relative to the total weight of the composition.

The composition typically comprises from 0.01% to 2% by weight of the crosslinking agent, preferably a peroxide, relative to the total weight of the composition.

According to one embodiment, the composition comprises from 0.1% to 20% by weight of additives, relative to the total weight of the composition.

According to one embodiment, the composition additionally comprises from 0.5% to 10%, preferably from 0.5% to 8%, by weight of foaming agent, relative to the total weight of the composition.

According to one embodiment, the composition of the present invention can additionally comprise a polyolefin (c) and/or a thermoplastic elastomeric polymer (d).

According to one embodiment, the composition of the invention comprises:
a copolymer (a) chosen from an ethylene-vinyl acetate (EVA) copolymer, a copolymer of ethylene and of alkyl (meth)acrylate and/or mixtures thereof,
a branched copolymer (b) containing polyamide blocks and polyether blocks, the number-average functionality (Efn) of which is greater than 2, preferably greater than or equal to 3,
optionally a polyolefin (c) and/or a thermoplastic elastomeric polymer (d),
a crosslinking agent, preferably a peroxide.

According to one embodiment, the composition comprises:
from 30% to 99.9%, typically from 50% to 99.9%, preferably from 60% to 99.9%, more preferentially from 70% to 99.9%, by weight of a copolymer (a) chosen from an ethylene-vinyl acetate (EVA) copolymer, a copolymer of ethylene and of alky (meth)acrylate and/or mixtures thereof,
from 0.1% to 40%, preferably from 0.1% to 30%, by weight of a branched copolymer (b) containing polyamide blocks and polyether blocks, the number-average functionality (Efn) of which is greater than 2, preferably greater than or equal to 3,
from 0% to 50%, preferably from 0.1% to 40%, or 0.1% to 30%, or 0.1% to 20%, by weight, relative to the total weight of the composition, of a polyolefin (c) and/or a thermoplastic elastomeric polymer (d)
from 0.01% to 2% by weight of a crosslinking agent, preferably a peroxide, and the total amounting to 100% by weight.

Preferably, the composition comprises from 0.1% to 50%, preferably from 0.1% to 40%, or 0.1% to 30%, or 0.1% to 20%, by weight, relative to the total weight of the composition, of a polyolefin (c) and/or a thermoplastic elastomeric polymer (d).

The polyolefin (c) can be functionalized or nonfunctionalized or be a mixture of at least one which is functionalized and/or at least one which is nonfunctionalized. The polyolefin (c) is preferably a functionalized polyolefin (c1).

The thermoplastic elastomeric polymer (d) can typically be chosen from a copolymer containing polyester blocks and polyether blocks, a line copolymer IN containing polyamide blocks and polyether blocks (PEBA), a polyurethane, an olefinic thermoplastic elastomer or an olefinic block copolymer, a styrene-diene block copolymer, and/or mixtures thereof.

The invention also relates to a process for preparing a composition as described above, comprising:
(i) a step of providing a mixture comprising:
   a copolymer (a),
   a copolymer (b),
   a crosslinking agent, preferably a peroxide, and
   optionally a polyolefin (c), a thermoplastic elastomeric polymer (d), and at least one additive;
(ii) a step of shaping the mixture by injection moulding, compression/moulding or extrusion.

The above steps can be carried out separately or simultaneously. The steps of the preparation process can be performed in the same item of equipment, for example in a mixer or an extruder.

The composition according the invention can be in the form of granules, rods, extruded sheets, or extruded or injection moulded parts.

According to one embodiment, step (i) is carried out by mixing, typically in the molten state:
from 30% to 99.9%, typically from 50% to 99.9%, preferably tom 60% to 99.9%, by weight of the copolymer (a);
from 0.1% to 50%, typically from 0.1% to 40%, preferably from 0.1% to 30%, by weight of the copolymer (b);
from 0% to 50% by weight of the polyolefin (c) and/or the thermoplastic elastomeric polymer (d);
from 0% to 20%, preferably from 0.1% to 20%, by weight of at least one 75 additive;
from 0.01% to 2% by weight of the crosslinking agent, preferably a peroxide;
   the total amounting to 100% by weight of the mixture.

According to one aspect, the invention relates to a crosslinked foam formed on the basis of a composition as described above.

The invention also relates to a process for preparing a foam, comprising:
(i) a step of providing a mixture comprising:
   a copolymer (a),
   a copolymer (b),
   a crosslinking agent, preferably a peroxide,
   a foaming agent, preferably a chemical foaming agent, and
   optionally a polyolefin (c), a thermoplastic elastomeric polymer (d), and at least one additive;
(ii) a step of shaping the mixture by injection moulding, compression/moulding or extrusion;
(iii) a step of foaming the mixture.

The above steps can be carried out separately or simultaneously.

According to one embodiment, steps (i)+% (ii)+(iii) or (i)+(ii)+(iii) are carried out simultaneously.

The steps of the preparation process can be performed in the same item of to equipment, for example in a mixer or an extruder.

According to one embodiment, step (i) is carried out by mixing, in the molten state:
from 30% to 99.9%, typically from 50% to 99.9%, preferably fam 60% to 99.9%, by weight of the copolymer (a);
from 0.1% to 50%, typically from 0.1% to 40%, preferably from 0.1% to 30%, by weight of the copolymer (b);
from 0% to 50% by weight of the polyolefin (c) and/or the thermoplastic elastomeric polymer (d);
from 0% to 20%, preferably from 0.1% to 20%, by weight of at least one additive;
from 0.01% to 2% by weight of the crosslinking agent, preferably a peroxide;
from 0.5% to 10% by weight of the foaming agent, preferably a chemical foaming agent,
   the total amounting to 100% by weight of the mixture.

According to another variant, the foaming agent is introduced during and/or alter step (i). The amount of the taming agent introduced into the process is typically from 0.5% to 10% by weight relative to the total weight of the mixture.

In this case, the mixture introduced in step (i) is a composition as defined above.

The invention also relates to a composition or a foam capable of being obtained according to the process described above.

The process of the invention makes it possible to prepare a polymer foam which is regular, homogeneous and has the above-mentioned advantageous properties.

The present invention thus provides a an as described above, which has a low density, is homogeneous and regular, and has one or more advantageous properties from among: a high capacity for restoring elastic energy during low-stress loading; a low compression set (and hence improved durability) a high rebound resilience; and improved resilience properties.

This is accomplished by virtue of the introduction of a particular PEBA copolymer into a crosslinked foam of ethylene-vinyl acetate (EVA) and/or of ethylene and of alkyl (meth)acrylate.

Typically, the foam obtained at the end of the preparation process deserted above consists essentially, or consists, at
the (co)polymers forming a polymer matrix of the foam, and
the decomposition products and/or the byproducts generated from the at least one taming agent and from the at least one crosslinking agent and optionally at least one additive, which are located dispersed in the polymer matrix.

The invention relates to the use of a composition or a foam as described above for the production of an article, preferably a shoe sole.

The invention also relates to an article consisting of or comprising at least one element of a composition or a foam as described above.

The article can be chosen from shoe soles, in particular sports shoe soles, large or small balls, gloves, personal protective equipment, rail pads, motor vehicle parts, construction parts and electrical and electronic equipment parts.

The invention will now be described in more detail.

### DETAILED DESCRIPTION

Copolymer (a)

The copolymer (a) according to the invention is a copolymer chosen from an ethylene-vinyl acetate (EVA) copolymer, a copolymer of ethylene and of alkyl (meth)acrylate and/or mixtures thereof.

The relative amount of vinyl acetate comonomer incorporated into the EVA copolymer can be from 0.1% by weight up to 40% by weight of the total copolymer, or even more. For example, the EVA may have a vinyl acetate content of from 2% to 50% by weight, 5% to 40% or 10% to 30% by weight. The EVA can be modified by processes well known to those skilled in the art, including modification with an unsaturated carboxylic acid or derivatives thereof, such as maleic anhydride or maleic acid.

The copolymer of ethylene and of alkyl (meth)acrylate comprises repeat units derived from ethylene and from alkyl acrylate, from alkyl methacryalte, or combinations thereof, in which the alkyl fragment contains from 1 to 8 carbon atoms. Examples of alkyl include methy, ethyl, propyl, butyl or combinations of two or more of these. The alkyl (meth)acrylate comonomer may be incorporated into the ethylene/alkyl (meth)acrylate copolymer in an amount of from 0.1% by weight to 45% by weight of the total copolymer or even more. The alkyl group can contain 1 to around 8 carbon atoms. For example, the alkyl (meth)acrylate comonomer can be present in the copolymer in an amount of from 5% to 45%, 10% to 35% or 10% to 28% by weight. Examples of ethylene-alkyl (meth)acrylate copolymer include ethylene/methyl acrylate, ethylene/ethyl acrylate, ethylene/butyl acrylate, or combinations of two or more of these. A mixture of two or more different ethylene-alkyl (meth)acrylate copolymers can be used.

The copolymer (a) can have a melt flow index (MFI) of from 0.1 to 60 g/10 minutes, or from 0.3 to 30 g/10 minutes. Preferably, the copolymer (a) has a low melt flow index, for example from 0.1 to 20, or from 0.5 to 20, or 0.5 to 10, or from 0.1 to 5 g/10 minutes.

In the context of the invention, the melt low indices (MFI) were measured at a temperature of 190° C. under a load of 2160 grams (units expressed in g/10 minutes) according to the standard ISO 1133, unless indicated otherwise.

Copolymer (b)

The branched PEBA copolymer generally has an instantaneous hardness of less than or equal to 72 Shore D, more preferably less than or equal to 68 Shore D or to 55 Shore D or to 45 Shore D. The hardness measurements can be carried out TO according to the standard ISO 868:2003.

Three types of polyamide blocks can advantageously be used.

According to a first type, the polyamide blocks originate from the condensation of a dicarboxylic acid, in particular those containing from 4 to 36 carbon atoms, preferably those containing from 6 to 18 carbon atoms, and of a diamine, in IN particular those containing from 2 to 20 carbon atoms, preferably those containing from 5 to 14 carbon atoms.

As examples of dicarboxylic acids, mention may be made of 1,4-cyclohexanedicarboxylic acid, butanedioic acid, adipic acid, azelaic acid, suberic acid, sebacic acid, dodecanedicarboxylic acid, octadecanedicarboxylic acid, terephthalic acid and isophthalic acid, but also dimerized fatty acids.

As examples of diamines, mention may be made of tetramethylenediamine, hexamethylenediamine, 1,10-decamethylenediamine, dodecamethylenediamine, trimethylhexamethylenediamine, the isomers of bis(4-aminocyclohexyl)methane (BACM), bis(3-methyl-4-aminocyclohexyl)methane (BMACM) and 2,2-bis(3-methyl-aminocyclohexyl)propane (BMACP), para-aminodicyclohexylmethane (PACM), isophoronediamine (IPDA), 2,6-bis(aminomethyl)norbornane (BAMN) and piperazine (Pip).

Advantageously, polyamide blocks PA 4.12, PA 4.14, PA 4.18, PA 6.10, PA 6.12, PA 6.14, PA 6.18, PA 9.12, PA 10.10, PA 10.12, PA 10.14 and PA 10.18 are used. In the notation PA X. Y, X represents the number of carbon atoms derived from the diamine residues and Y represents the number of carbon atoms derived from the diacid residues, as is conventional.

According to a second type, the polyamide blocks result from the condensation of one or more α,ω-aminocarboxylic acids and/or of one or more lactams containing from 6 to 12 carbon atoms in the presence of a dicarboxylic acid containing from 4 to 12 carbon atoms or of a amine. As examples of lactams, mention may be made of caprolactam, oenantholactam and lauryllactam. As examples of α,ω-aminocarboxylic acids, mention may be made of aminocaproic acid, 7-aminoheptanoic acid, 11-aminoundecanoic acid and 12-aminododecanoic acid.

Advantageously, the polyamide blocks of the second type are PA 11 (polyundecanamide), PA 12 (polydodecanamide) or PA 6 (polycaprolactam) blocks. In the notation PA X, X represents the number of carbon atoms derived from amino acid residues.

According to a third type, the polyamide blocks result from the condensation of at least one α-aminocarboxylic acid (or a lactam), at least on diamine and at least one dicarboxylic acid.

In this case, the polyamide PA blocks are prepared by polycondensation:
of the linear aliphatic or aromatic diamine(s) containing X carbon atoms;
of the dicarboxylic acid(s) containing Y carbon atoms; and
of the comonomer(s) (Z), chosen from lactams and α,ω-aminocarboxylic acids containing Z carbon atoms and equimolar mixtures of at least one diamine containing X1 carbon atoms and of at least one dicarboxylic acid containing Y1 carbon atoms, (X1, Y1) being different from (X, Y);
   said comonomer(s) {Z} being introduced in a weight proportion advantageously ranging up to 50%, preferably up to 20%, even more advantageously up to 10%, relative to the total amount of polyamide-precursor monomers;
in the presence of a chain limiter chosen from dicarboxylic acids.

Advantageously, the dicarboxylic acid containing Y carbon atoms is used as chain limiter, which is introduced in excess relative to the stoichiometry of the diamine(s).

According to one variant of this third type, the polyamide blocks result from the condensation of at least two α,ω-aminocarboxylic acids or from at least two lactams containing from 6 to 12 carbon atoms or from one lactam and one aminocarboxylic acid not having the same number of carbon atoms, in the optional presence of a chain limiter. As examples of aliphatic α,ω-aminocarboxylic acids, mention may be made of aminocaproic acid, 7-aminoheptanoic acid, 11-aminoundecanoic acid and 12-aminododecanoic acid.

As examples of lactams, mention may be made of caprolactam, oenantholactam and lauryllactam. As examples of aliphatic diamines, mention may be made of hexamethylenediamine, dodecamethylenediamine and trimethylhexanethylenediamine. As examples of cycloaliphatic diacids, mention may be made of 1,4-cyclohexanedicarboxylic acid. As examples of aliphatic diacids, mention may be made of butanedioic acid, adipic acid, azelaic acid, suberic acid, sebacic acid, dodecanedicarboxylic acid and dimerized fatty acids. These dimerized fatty acids preferably have a dimer content of at least 96%; they are preferably hydrogenated; they are, for example, products sold under the m brand name Pripol by Croda, or under the brand name Empol by BASF, or under the brand name Radiacid by Oleon, and polyoxyalkylene α,ω-diacids. As examples of aromatic diacids, mention may be made of terephthalic acid (T) and isophthalic acid (I). As examples of cycloaliphatic diamines, mention may be made of the isomers of bis(4-aminocyclohexyl)methane (BACM), bis(3-methyl-4-aminocyclohexyl)methane (BMACM) and 2,2-bis(3-methyl)-4-aminocyclohexyl)propane (BMACP), and par-aminodicyclohexylmethane (PACM). The other diamines commonly used may be isophoronediamine (PDA), 2,6-bis(aminomethyl)norbornane (BAMN) and piperazine.

As examples of polyamide blocks of the third type, mention may be made of the following:
PA 6.6/6, wherein 6.6 denotes hexamethylenediamine units condensed with adipic acid and 6 denotes units resulting from the condensation of caprolactam;
PA 6.6/6.10/11/12, wherein 6.6 denotes hexamethylenediamine condensed with adipic acid, 6.10 denotes hexamethylenediamine condensed with sebacic acid, 11 denotes units resulting from the condensation of aminoundecanoic acid, and 12 denotes units resulting from the condensation of lauryllactam.

The notations PA X/Y, PA X/Y/Z, etc. relate to copolyamides, wherein X, Y, Z, etc. represent homopolyamide units as described above.

As examples of copolyamides, mention may be made of copolymers of caprolactam and of lauryllactam (PA 6112), copolymers of caprolactam, of adipic acid and of hexamethylenediamine (PA 6166), copolymers of caprolactam, of lauryllactam, of adipic acid and of hexamethylenediamine (PA 6/12/66), copolymers of caprolactam, of lauryllactam, of 11-aminoundecanoic acid, of azelaic acid and of hexamethylenediamine (PA 6/69/11/12), copolymers of caprolactam, of lauryllactam, of 11-aminoundecanoic acid, of adipic acid and of hexamethylenediamine (PA 6/66/11/12), copolymers of lauryllactam, of azelaic acid and of hexamethylenediamine (PA 69/12), copolymers of 11-aminoundecanoic acid, of terephthalic acid and of decamethylenediamine (PA is 11/10T).

Advantageously, the polyamide blocks of the copolymer (b) comprise polyamide blocks chosen from PA 6, PA 11, PA 12, PA 5.4, PA 5.9, PA 5.10, PA 5.12, PA 5.13, PA 5.14, PA 5.16, PA 5.18, PA 5.36, PA 6.4, PA 6.9, PA 6.10, PA 6.12, PA 6.13, PA 6.14, PA 6.16, PA 6.18, PA 6.36, PA 10.4, PA 10.9, PA 10.10, PA 10.12, PA 10.13, PA 10.14, PA 10.16, PA 10.18, PA 10.36, PA 10.T, PA 12.4, PA 12.9, PA 12.10, PA 12.12, PA 12.13, PA 12.14, PA 12.16, PA 12.18, PA 12.36, PA 12.T, PA6112, PA11/12, PA11110.10 or mixtures or copolymers thereof; and preferably comprise blocks of polyamide PA 6, PA 11, PA 12, PA 6.10, PA 10.10, PA 10.12, PA6112, PA 11112 or mixtures or copolymers thereof.

The polyether blocks of the PEBA copolymer are formed from alkylene oxide units. The polyether blocks can in particular be PEG (polyethylene glycol) blocks, i.e. blocks formed from ethylene oxide units, and/or PPG (polypropylene glycol) blocks, i.e. blocks formed from propylene oxide units, and/or PO3G (polytrimethylene glycol) blocks, i.e. blocks formed from trimethylene glycol ether units, and/or PTMG (polytetramethyleneglycol) blocks, i.e. blocks formed from tetramethylene glycol unis, also known as polytetrahydrofuran. The copolymers may comprise in their chain several types of polyethers, the copolyethers possibly being in block or random form.

Use may also be made of blocks obtained by oxyethylation of bisphenols, such as, for example, bisphenol A. The latter products are described in particular in the document EP 613 919.

The polyether blocks may also be formed from ethoxylated primary amines. As 3 examples of ethoxylated primary amines, mention may be made of the products of formula:

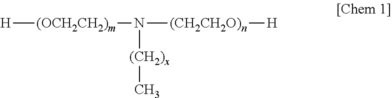

in which m and n are integers between 1 and 20 and x is an integer between 8 and 18. Theme products are for example commercially available under the brand name Noramox® from CECA and under the brand name Genamin® from Clariant.

The polyether blocks may comprise polyoxyalkylene blocks bearing NH₂ chain ends, such blocks being able to be obtained by cyanoacetylation of α,ω-dihydroxylated aliphatic polyoxyalkylene blocks known as polyether diols. More particularly, the commercial products Jeffamine or Elastamine may be used (for example Jeffamine® D1400, D2000, ED 2003, XTJ 542, which are commercial products from Huntsman, also described in documents JP 2004346274, JP 2004352794 and EP 1482011).

The polyether diol blocks are either used in unmodified form and copolycondensed with polyamide blocks bearing carboxylic end groups, or are aminated to be converted into polyetherdiamines and condensed with polyamide blocks bearing carboxylic end groups.

While the PEBA copolymers above comprise at least one polyamide block and at least one polyether block as described above, the present invention also covers the copolymers comprising three, four (or even more) different blocks chosen from those described in the present description, for example; polyester blocks, polysiloxane blocks, such as polydimethylsiloxane (PDMS) blocks, polyolefin blocks, polycarbonate blocks, and mixtures thereof. For example, the copolymer according to the invention can be a segmented block copolymer comprising three different types of blocks (or “triblock” copolymer), which results from the condensation of several of the blocks described above. Said triblock may for example be a copolymer comprising a polyamide block, a polyester block and a polyether block or a copolymer comprising a polyamide block and two different polyether blocks, for example a PEG block and a PTMG block.

PEBAs result from the polycondensation of polyamide blocks bearing reactive ends with polyether blocks bearing reactive ends, such as, inter ala, the polycondensation:
1) of polyamide blocks bearing diamine chain ends with polyoxyalkylene blocks bearing dicarboxylic chain ends;
2) of polyamide blocks bearing dicarboxylic chain ends with polyoxyalkylene blocks bearing diamine chain ends, obtained, for example, by cyanoethylation and hydrogenation of α,ω-dihydroxylated aliphatic polyoxyalkylene blocks, known as polyether diols;
3) of polyamide blocks bearing dicarboxylic chain ends with polyether diols, the products obtained being, in this particular case, polyetheresteramides.

The polyamide blocks bearing dicarboxylic chain ends originate, for example, a from the condensation of polyamide precursors in the presence of a chain-limiting dicarboxylic acid. The polyamide blocks bearing diamine chain ends originate, for example, from the condensation of polyamide precursors in the presence of a chain-limiting damine.

PEBA copolymers that are particularly preferred in the context of the invention are copolymers including blocks from among: PA 11 and PEG; PA 11 and PTMG; PA 12 and PEG; PA 12 and PTMG; PA 6.10 and PEG; PA 6.10 and PTMG; PA 6 and PEG; PA 6 and PTMG, PA 6112 and PTMG, PA 6112 and PEG, PA11/12 and PTMG, PA 11112 and PEG.

The PEBA copolymer according to the invention is a branched copolymer the number-average functionality (Efn) of which is greater than 2, preferably greater than or equal to 3.

Preferably, the branching is performed by a compound comprising at least three functions capable of reacting with be carboxylic acid chain ends of the PEBA copolymer, thus making it possible to form a branched PEBA copolymer.

According to a first variant, the branching is performed by a polyol residue binding polyamide blocks of the PEBA copolymer, said polyol being a polyol comprising at least three hydroxyl groups.

According to this variant, the branched PEBA can for example be prepared by the addition during is synthesis of one or more polyols comprising at least three hydroxyl groups.

The branched PEBA can be prepared according to a two-step preparation process (comprising a first step of synthesis of the polyamide blocks then a second step of condensation of the polyamide and polyether blocks) or by a one-step preparation process. The polyol is added with the precursors of the polyamide blocks.

The general method for the two-step preparation of the PEBA copolymers having ester bonds between the PA blocks and the PE blocks is known and is described, for example, in document FR 2846332. The general method for the preparation of the PEBA copolymers having snide bonds between the PA blocks and the PE blocks is known and is described, for example, in document EP 1482011. The polyether blocks may also be mixed with polyamide precursors and a diacid chain limiter to prepare polymers containing polyamide blocks and polyether blocks having randomly distributed units (one-step process). Regardless of the method used (two-step or one-step), the polyol is added with the polyamide precursors.

Preferably, the branched PEBA of the invention is prepared according to a two-step preparing process.

The addition of a polyol with a functionality of greater than 2 gives rise to bridging bonds connecting together polyamide blocks of the copolymer, preferably by ester bonds.

A polyol comprising at least three hydroxyl groups is understood to mean in particular:
monomeric polyols, in particular monomeric phatic trials such as glycerol, trimethylpropane, pentaerythritol, and/or
polymeric polyols, in particular trials containing polyether chains, polycaprolactone triols, mixed polyether-polyester polyols comprising at least three hydroxyl groups.

Advantageously, the polyol is chosen from: pentaerythritol, trimethylolpropane, trimethylolethane, hexanetriol, digylcerol, methylglucoside, tetraethanol, sorbitol, dipentaerythritol, cyclodextrin, polyether polyols comprising at least three hydroxyl groups and mixtures thereof.

The weight-average molar mass of the polyol is preferably at most 3000 g/mol, more preferentially at most 2000 g/mol; and is generally in the range of from 50 to 1000 g/mol, preferably from 50 to 500 g/mol, preferably from 50 to 200 g/mol.

Advantageously, the polyol is added in an amount ranging from 0.01% to 10% by weight, preferably from 0.01% to 5% by weight, more preferably from 0.05% to is 0.5% by weight, relative to lie total weight of the polyol, of the precursors of the polyamide blocks and of the polyether blocks. The polyol is advantageously added in an amount of 3.5 to 35 μeq/g relative to the total weight of the polyol, of the precursors of the polyamide blocks and of the polyether blocks.

According to a second variant, the branching of the copolymer (b) is performed by a polyepoxide compound residue binding polyamide blocks of the copolymer (b), said polyepoxide compound being a polyepoxide compound comprising at least three epoxide functions.

According to this variant, the branched PEBA can be prepared according to a production process comprising a step of mixing, in the molten state,
a PEBA copolymer and an epoxide compound.

The epoxide equivalent weight (EEW) of the polyepoxide compound is typically from 80 to 2800 g/mol, preferably from 90 to 700 g/mol.

According to one embodiment, the epoxide compound is chosen from triglycidyl isocyanurate, trimethylolpropane triglycidyl ether, epoxy novolak resins, and epoxidized oils.

According to one embodiment, the epoxide compound is chosen from random copolymers of (meth)acrylates bearing epoxy functions obtained by copolymerization of at least one (meth)acrylic monomer bearing an epoxy function with at least one monomer chosen from an alkene monomer, a vinyl acetate monomer, a nonfunctional (meth)acrylic monomer, a styrene monomer, or mixtures of one or more of these entities.

For the purposes of the present invention, the term (meth)acrylic monomer includes both acrylic monomers and methacrylic monomers. Examples of (meth)acrylic monomers bearing an epoxy function include both acrylates and methacrylates. Examples of these (meth)acrylic monomers bearing an epoxy function include, but are not limited to, monomers containing 1,2-epoxy groups such as glycidyl acrylate and glycidyl methacrylate. Other suitable monomers may be allyl glycidyl ether, glycidyl ethacrylate and glycidyl itaconate.

Suitable alene monomers may be, but we not limited to, ethylene, propylene, is butylene, and mixtures of these entities.

Suitable acrylate and methacrylate monomers may be, but we not limited to, methyl acrylate, ethyl acrylate, n-propyl acrylate, isopropyl acrylate, n-butyl acrylate, sec-butyl acrylate, isobutyl acrylate, t-butyl acrylate, n-amyl acrylate, isoamyl acrylate, isobornyl acrylate, n-hexyl acrylate, 2-ethylbutyl acrylate, 2-ethylhexyl acrylate, n-octyl acrylate, n-decyl acrylate, methylcyclohexyl acrylate, cyclopentyl acrylate, cyclohexyl acrylate, methyl methacrylate, ethyl methacrylate, n-propyl methacrylate, n-butyl methacryalte, isopropyl methacrylate, isobutyl methacrylate, n-amyl methacrylate, n-hexyl methacrylate, isoamyl methacrylate, sec-butyl methacrylate, isoamyl methacrylate, butyl metacrylate, 2-ethylbutyl methacrylate, methylcyclohexyl methacrylate, cinnamyl methacrylate, crotyl methacrylate, cyclohexyl methacrylate, cyclopentyl methacrylate, 2-ethoxyethyl methacrylate and isobornyl methacrylate.

Styrene monomers include, but are not limited to, styrene, alpha-methylstyrene, vinyltoluene, p-methylstyrene, t-butylstyrene, o-chlorostyrene, vinylpyridine and mixtures of these entities. In certain embodiments, the styrene monomers for use in the present invention ae styrene and alpha-methylstyrene.

According to one embodiment, the epoxide compound is chosen from random styrene-(meth)acrylate copolymers bearing epoxy functions obtained from monomers of at least one (meth)acrylic monomer bearing an epoxy function and of at least one nonfunctional (meth)acrylic and/or styrene monomer.

In one embodiment, the epoxide compound contains between 25% and 50% by weight of at least one (meth)acrylic monomer bearing an epoxy function and 75% to 50% of at least one nonfunctional (meth)acrylic and/or styrene monomer. More preferentially, the epoxide compound contains between 25% and 50% by weight of a least one (meth)acrylic monomer bearing an epoxy function, between 15% and 30% by weight of at least one styrene monomer, and between 20% and 60% by weight of at least one nonfunctional acrylate and/or To methacrylate monomer.

In one embodiment, the epoxide compound contains between 50% and 80% by weight, based on the total weight of the monomers, of at least one (meth)acrylic monomer bearing an epoxy function and 20% to 50% of at least one nonfunctional (meth)acrylic and/or styrene monomer. More preferentially, the epoxide compound contains between 50% and 80% by weight of at least one (meth)acrylic monomer bearing an epoxy function, between 15% and 45% by weight of at least one styrene monomer, and between 0% and 5% by weight of at least one nonfunctional acrylate and/or methacrylate monomer.

In one embodiment, the epoxide compound contains between 5% and 25% by weight of t least one (meth)acrylic monomer bearing an epoxy function and 75% to 95% of at least one nonfunctional (meth)acrylic and/or styrene monomer.

More preferentially, the epoxide compound contains between 5% and 25% by weight of at least one (meth)acrylic monomer bearing an epoxy function, between 50% and 95% by weight of at least one styrene monomer, and between 0% and 25% by weight of at least one nonfunctional acylate and/or methacrylate monomer.

According to embodiments, the epoxide compound is chosen from styrene-(meth)acrylate copolymers bearing epoxy functions obtained from monomers of at least one (meth)acrylic monomer bearing an epoxy function and of at least one nonfunctional (meth)acrylic and/or styrene monomer, preferably chosen from styrene-(meth)acrylate copolymers bearing epoxy functions obtained from monomers of at least one (meth)acrylic monomer bearing an epoxy function and of at least one styrene monomer.

According to one embodiment, the epoxide compound is obtained from at least one (meth)acrylic monomer bearing an epoxy function and at least one styrene monomer. According t one embodiment, the epoxide compound contains from 50% to 80% by weight, relative to the total weight of the monomers, of at least 3 one (meth)acrylic monomer bearing an epoxy function and between 20% and 50% by weight of at least one styrene monomer.

According to one preferred embodiment, the epoxide compound is a random copolymer of styrene and of glycidyl methacrylate.

The weight-average molar mass (Mw) of the styrene-(meth)acrylate copolymer bearing epoxy functions is preferably less than 25 000 g/mol, more preferentially less than 20 000 g/mol; and is generally in the range of from 3000 to 15 000 g/mol, preferably from 5000 to 10 000 g/mol.

According to one embodiment, the amount of the polyepoxide compound used in the process is from 0.01% to 5% by weight, preferably from 0.01% to 2% by IN weight, and more preferably from 0.05% to 1% by weight, relative to the total weight of the PEBA copolymer.

According to one preferential embodiment, the amount of the polyepoxide compound used in the process is less than 1%, typically from 0.15% to 0.95%, preferably from 0.3% to 0.9%, or else from 0.35% to 0.85%, by weight relative to 2p the total weight of the PEBA copolymer.

According to one embodiment, the molar ratio of the carboxylic acid chain end content of the PEBA copolymer to the epoxide function content of the polyepoxide compound is typically between 2 and 20, preferably between 3 and 10.

Advantageously, the process is carried out by reactive extrusion, typically in an extruder.

In the case of the invention, the branched PEBA copolymer has a weight-average molar mass Mw of greater than 80 000 g/mol. Preferably, the weight-average molar mass of the branched PEBA copolymer ranges from 80 000 to 300 000 g/mol, more preferentially from 90 000 to 250 000 g/mol, even more preferentially from 100 000 to 200 000 g/mol.

The weight-average molar mass is expressed as PMMA equivalents (used as a calibration standard) and can be measured by size exclusion chromatography according to the standard ISO 16014-1:2012, the copolymer being dissolved in hexafluoroisopropanol stabilized with 0.05 M potassium trifluoroacetate for 24 h at ambient temperature at a concentration of from 1 g/l to 2 g/l before being passed through the columns, for example at a flow rate of 1 ml/min, the molar mass being measured by a differential refractometer. The size exclusion chromatography can be carried out using columns of modified silica, for example on a set of two column and a pre-column of modified silica (such as the PGF column and pre-columns from Polymer Standards Service) comprising a 1000 Å column, having dimensions of 300×8 mm and a particle size of 7 μm, a 100 Å column, having dimensions of 300×8 mm and a particle size of 7 μm, and a pre-column having dimensions of 50×8 mm, for example at the temperature of 40° C.

In certain embodiments, the branched PEBA copolymer has a weight-average molar mass MW ranging from 80 000 to 90 000 g/mol, or from 90 000 to 100 000 g/mol, or from 100 000 g/mol to 125 000 g/mol, or from 125 000 to 150 000 g/mol, or from 150 000 to 175 000 g/mol, or from 175 000 to 200 000 g/mol, or from 200 000 to 225 000 g/mol, or from 225 000 to 250 000 g/mol, or from 250 000 to 275 000 g/mol, or from 275 000 to 300 000 g/mol.

The branched PEBA copolymer can have a number-average molar mass Mn ranging from 30 000 to 100 000 g/mol, preferably from 35 000 to 80 000 g/mol, more preferentially from 40 000 to 70 000 g/mol.

The number-average molar mass is expressed as PMMA equivalents and can be measured according to the standard ISO 16014-1 according to the method described above. In certain embodiments, the branched copolymer containing rigid blocks and flexible blocks has a number-average molar mass Mn ranging from 30 000 to 35000 g/mol, or from 35 000 to 40 000 g/mol, or from 40 000 to 45 000 g/mol, or from 45 000 to 50 000 g/mol, or from 50 000 to 55 000 g/mol, or from 55 000 to 60 000 g/mol, or from 60 000 to 70 000 g/mol, or from 70 000 to 80 000 g/mol, or from 80 000 to 90 000 g/mol, or from 90 000 to 100 000 g/mol.

The branched PEBA copolymer can have a z-average molar mass Mz ranging from 200 000 to 1 000 000 g/mol. The z-average molar mass is expressed as PMMA equivalents and can be measured according to the standard ISO 16014-1 according to the method described above. In certain embodiments, the branched copolymer containing rigid blocks and flexible blocks has a z-average molar mass Mz ranging from 200 000 to 250 000 g/mol, or from 250 000 to 1 300 000 g/mol, or from 300 000 to 350 000 g/mol, or from 350 000 to 400 000 g/mol, or from 400 000 to 450 000 g/mol, or from 450 000 to 500 000 g/mol, 500 000 to 550 000 g/mol, 550 000 to 600 000 g/mol, 600 000 to 650 000 g/mol, 650 000 to 700 000 g/mol, 700 000 to 750 000 g/mol, 750 000 to 800 000 g/mol, 850 000 to 900 000 g/mol, 950 000 to 1 000 000 g/mol. The TO polydispersity of the copolymer can be defined by the ratio of the weight-average molar mass Mw of the copolymer to the number-average molar mass Mn of the copolymer (MW/Mn molar mass ratio) and/or by the ratio of the z-average molar mass Mz of the copolymer to the weight-average molar mass Mw of the copolymer (Mz/Mw molar mas ratio).

The branched PEBA copolymer has an Mw/Mn molar mass ratio of greater than or equal to 2.2, preferably greater than or equal to 2.4. In certain embodiments, the copolymer has an Mw/Mn molar mass ratio of greater than or equal to 2.3, or greater than or equal to 2.4, or greater than or equal to 2.5, or greater than or equal to 2.6, or greater than or equal to 2.7, or greater than or equal to 2.8, or m greater than or equal to 2.9, or greater than or equal to 3.

The branched PEBA copolymer can have an Mz/Mw molar mass ratio of greater than or equal to 1.8, preferably greater than or equal to 2.0, preferably greater than or equal to 2.5, or greater than or equal to 2.7, or greater than or equal to 2.9, or greater than or equal to 3.1, or greater than or equal to 3.3, or greater than or equal to 3.5.

Polyolefin (C)

The composition can comprise a polyolefin (c) chosen from functionalized polyolefins (c1) and nonfunctionalized polyolefins (c2) and mixtures thereof.

The polyolefin can typically have a flexural modulus of less than 100 MPs, measured according to the standard ISO 178, and a Tg of less than 0° C. (measured according to the standard 11357-2 at the inflection point of the DSC thermogram).

A nonfunctionalized polyolefin (c2) is conventionally a homopolymer or copolymer of alpha-olefin or of diolefins, such as, far example, ethylene, propylene, 1-butene, 1-octene or butadiene. Mention may be made, by way of example, of:
polyethylene homopolymers and copolymers, in particular LDPE, HDPE, LLDPE (linear low density polyethylene), VLDPE (very low density polyethylene) and metallocene polyethylene,
propylene homopolymers or copolymers,
ethylene/alpha-olefin copolymers, such as ethylene/propylene, EPRs (abbreviation of ethylene-propylene rubbers) and ethylene/propylene/dienes (EPDMs).

The functionalized polyolefin (c1) can be a polymer of alpha-olefins having reactive units; such reactive units are acid, anhydride or epoxide functions. Mention may be made, by way of example, of the preceding polyolefins (C2) is grafted or copolymerized or terpolymerized with unsaturated epoxides, such as glycidyl (meth)acrylate, or with carboxylic acids or the corresponding salts or esters, such as (meth)acrylic acid (it being possible for the latter to be completely or partially neutralized by metals such as Zn, and the like), or else with carboxylic acid anhydrides, such as maleic anhydride. A functionalized polyolefin is, for example, a PE/EPR mixture, the ratio by weight of which can vary within broad limits, for example between 4060 and 90110, said mixture being cografted with an anhydride, in particular maleic anhydride, according to a degree of grafting, for example, from 0.01% to 5% by weight.

The functionalized polyolefin (c1) can be chosen from the following (co)polymers, grafted with maleic anhydride or glycidylmethacrylate, in which the degree of grafting is, for example, from 0.01% to 5% by weight:
PE, PP, copolymers of ethylene with propylene, butene, hexene or octene containing, for example, from 35% to 80% by weight of ethylene;
ethylene/alpha-olefin copolymers, such as ethylene/propylene, EPRs (abbreviation of ethylene-propylene rubbers) and ethylene/propylene/dienes (EPDMs);
copolymers of ethylene and vinyl acetate (EVA), containing up to 40% by weight of vinyl acetate;
copolymers of ethylene and alkyl (meth)acrylate, containing up to 40% by weight of alky (meth)acrylate;
copolymers of ethylene and vinyl acetate (EVA) and alkyl (meth)acrylate, containing up to 40% by weight of comonomers.

The functionalized polyolefin (c1) can also be chosen from ethylene/propylene copolymer, predominant in propylene, grated with maleic anhydride and then condensed with monoaminated polyamide (or a polyamide oligomer) (products TO described in EP-A-0 342 066).

The functionalized polyolefin (c1) can also be a copolymer or terpolymer of at least the following units: (1) ethylene, (2) alkyl (meth)acrylate or saturated carboxylic acid vinyl ester and (3) anhydride, such as maleic or (meth)acrylic acid anhydride, or epoxide, such as glycidyl (meth)acrylate.

Mention may be made, as examples of functionalized polyolefins of the latter type, of the following copolymers, where ethylene preferably represents at least 60% by weight and where the termonomer (the functional group) represents, for example, from 0.1% to 10% by weight of the copolymer.
ethylene/alkyl(meth)acrylate/(meth)acrylic acid or maleic anhydride or glycidyl methacrylate copolymers;
ethylene/vinyl acetate/maleic anhydride or glycidylmethacrylate copolymers;
ethylene/vinyl acetate or alkyl (meth)acrylate/(meth)acrylic acid or maleic anhydride or glycidyl methacrylate copolymers.

In the preceding copolymers, the (meth)acrylic acid can be sallied with Zn or Li.

The term “alkyl (meth)acrylate” in (c1) or (c2) denotes C₁ to C₈ alkyl methacrylates and acrylates and can be chosen from methyl acrylate, ethyl acrylate, n-buty acylate, isobutyl acrylate, 2-ethylhexyl acrylate, cyclohexyl acrylate, methyl methacrylate and ethyl methacrylate.

The abovementioned copolymers, (c1) and (c2), can be copolymerized in random or block fashion and can exhibit a linear or branched structure.

The nonfunctionalized polyolefins (c2) are advantageously chosen from polypropylene homopolymers or copolymers, and any ethylene homopolymer, or 3 copolymer of ethylene and of a comonomer of higher alpha-olefin type, such as butene, hexene, octene or 4-methyl-1-pentene. Mention may be made, for example, of PPs, high density PEs, medium density PEs, linear low density PEs, low density PEs or ultra low density PEs. These polyethylenes are known by a person skilled in the art to be produced according to a “radical” process, according to a “Ziegler” type catalysis or, more recently, according to a “metallocene” catalysis.

The functionalized polyolefins (c1) are advantageously chosen from any polymer comprising alpha-olefin units and units bearing reactive polar functions, such as epoxide, carboxylic acid or carboxylic acid anhydride functions. Mention may be made, by way of example of such polymers, of terpolymers of ethylene, of alkyl acrylate and of maleic anhydride or of glycidyl methacrylate, such as the Lotader® products, or polyolefins grafted with maleic anhydride, such as the Orevac® products, and also terpolymers of ethylene, of alkyl acrylate and of (meth)acrylic acid. Mention may also be made of homopolymers or copolymers of polypropylene grafted with a carboxylic acid anhydride and then condensed with polyamides or oligomers, which are monoaminated, of polyamide.

It has been observed that the functionalized polyolefin (c) can improve the compatibility between the copolymer (a) and the copolymer (b).

According to one embodiment, the composition comprises from 0.1% to 50%, preferably 0.1% to 40%; or 0.1% to 30%, or 0.1% to 20%, by weight, relative to the total weight of the composition, of a polyolefin (c) as described above.

Thermoplastic Elastomeric Polymer (d)

According to one embodiment, the composition comprises from 0.1% to 50%, preferably 0.1% to 40%; or 0.1% to 30%, or 0.1% to 20%, by weight, relative to the total weight of the composition, of a thermoplastic elastomeric polymer (d) chosen from a copolymer containing polyester blocks and polyether blocks, a linear PEBA, a polyurethane, an olefinic thermoplastic elastomer or an olefinic block copolymer, a styrene-diene block copolymer, and/or mixtures thereof.

The copolymer containing polyester blocks and polyether blocks typically consists of flexible polyether blocks derived from polyether dials and of rigid polyester blocks which result from the reaction of at least one dicarboxylic acid with at least one chain-extending short diol unit. The polyester blocks and the polyether blocks are connected via ester bonds resulting from the reaction of the acid functions of the dicarboxylic acid with the hydroxyl functions of the polyether diol. The sequence of polyethers and of diacids forms the flexible blocks whereas the sequence of glycol or of butanediol with diacids forms the rigid blocks of the copolyetherester. The chain-extending short dial may be chosen from the group consisting of neopentyl glycol, cyclohexanedimethanol and aliphatic glycols of formula HO(CH2)nOH in which n is an integer ranging from 2 to 10.

Advantageously, the diacids are aromatic dicarboxylic acids containing from 8 to 14 carbon atoms. Up to 50 mol % of the aromatic dicarboxylic acid may be replaced with at least one other aromatic dicarboxylic acid containing from 8 to 14 carbon atoms, and/or up to 20 mol % may be replaced with an aliphatic dicarboxylic acid containing from 2 to 14 carbon atoms.

As examples of aromatic dicarboxylic acids, mention may be made of terephthalic acid, isophthalic acid, dibenzoic acid, naphthalenedicarboxylic acid, 4,4-diphenylenedicarboxylic acid, bis(p-carboxyphenyl)methane acid, ethylenebis-p-benzoic acid, 1,4-tetramethylenebis(p-oxybenzoic acid), ethylenebis(p-oxybenzoic acid) and 1,3-trimethylenebis(p-oxybenzoic acid).

As examples of glycols, mention may be made of ethylene glycol, 1,3-trimethylene glycol, 1,4-tetramethylene glycol, 1,6-hexamethylene glycol, 1,3-propylene glycol, 1,8-octamethylene glycol, 1,10-decamethylene glycol and 1,4-cyclohexylenedimethanol. The copolymers containing polyester blocks and polyether blocks are, for example, copolymers containing polyether units derived from polyether diols such as polyethylene glycol (PEG), polypropylene glycol (PPG), polytrimethylene glycol (PO3G) or polytetramethylene glycol (PTMG), dicarboxylic acid units such as terephthalic acid and glycol (ethanediol) or 1,4-butanediol units. Such copolyetheresters are described in patents EP 402 883 and EP 405 227. These polyetheresters are thermoplastic elastomers. They may contain plasticizers.

The composition may comprise a linear PEBA. The number-average molar mass Mn of the polyamide blocks in the linear copolymer is preferably from 400 to 13 000 g/mol, more preferentially from 500 to 10 000 g/mol and even more preferentially from 600 to 9000 g/mol or between 600 and 6000 g/mol. The number-average molar mass of the polyether blocks s preferably from 100 to 3000 g/mol, preferably from 200 to 2000 g/mol.

The number-average molar mass is set by the content of chain limiter. It can be calculated according to the relationship:

Mn=nₘₒₙₒₘₑᵣ×MW_{repeating unit}/n_{chain limiter}+MW_{chain limiter}

In this formula, nₘₒₙₒₘₑᵣ represents the number of moles of monomer, n_{chain limiter} represents the number of moles of chain limiter in excess, MW_{repeating unit} represents the molar mass of the repeating unit, and MW_{chain limiter} represents the molar mass of chain limiter in excess.

The number-average molar mass of the polyamide blocks and of the polyether blocks can be measured before the copolymerization of the blocks by gel permeation chromatography (GPC) according to the standard ISO 16014-1:2012 in tetrahydrofuran.

Advantageously, the mass ratio of the polyamide blocks relative to the polyether blocks of the copolymer is from 0.1 to 20, preferably from 0.3 to 5, even more preferentially from 0.3 to 2.

The thermoplastic polyurethanes are linear or slightly branched polymers consisting of hard blocks and flexible elastomeric blocks. They can be produced by reacting flexible elastomeric polyethers having a hydroxyl end group or polyesters with diisocyanates such as methylene diisocyanate or toluene diisocyanate. These polymers may be chain-extended with glycols, diamines, diacids or amino alcohols. The products of reaction of isocyanates and alcohols are urethanes and these blocks are relatively hard with a high melting point. These hard blocks with a high melting point are responsible for the thermoplastic nature of the polyurethanes.

The olefinic thermoplastic elastomer comprises repeat units of ethylene and of higher primary olefins such as propylene, hexene, octene, or combinations of two or more of these and optionally of 1,4-hexadiene, ethylidenenorbornene, norbornadiene or combinations of two or more of these. The olefinic elastomer may be functionalized by grafting with an acid anhydride such as maleic anhydride.

The styrene-diene block copolymer comprises repeat units derived from polystyrene units and from polydiene units. The polydiene units are derived from polybutadiene, from polyisoprene units or from copolymers of the two. The copolymer may be hydrogenated to produce a saturated rubber backbone segment commonly known as styrene/butadiene/styrene (SBS) or styrene/isoprene/styrene (SIS) thermoplastic elastomers or styrene/ethylene-butene/styrene (SEBS) or styrene/ethylene-propylene/styrene (SEPS) block copolymers. They may also be functionalized by grafting with an acid anhydride such as maleic anhydride.

Crosslinking Agent

The composition comprises from 0.01% to 2%, preferably from 0.05% to 2%, or from 0.05% to 1.8%, by weight of a crosslinking agent, relative to the weight of the total composition. In general, the crosslinking agent is chosen from an agent enabling the crosslinking of the EVA, possibly comprising one or more organic peroxides, for example chosen from dialkyl peroxides, peroxyesters, peroxydicarbonates, peroxyketals, diacyl peracids, or combinations of two or more of these. Examples of peroxides include dicumyl peroxide, di(3,3,5-trimethylhexanoyl) peroxide, t-butyl peroxypivalate, t-butyl peroxyneodecanoate, di(sec-butyl) peroxydicarbonate, t-amyl peroxyneodecanoate, 1,1-di-t-butylperoxy-3,3,5-trimethylcyclohexane, t-butyl-cumyl peroxide, 2,5-dimethyl-2,5-di(tert-butylperoxy)hexane, 1,3-bis(tert-butylperylperoxyisopropyl)benzene, or combinations of two or more of these. These peroxide and others, are available under the brand name Luperox® sold by Arkema.

Foaming Agent

The composition may comprise from 0.5% to 10%, preferably from 0.5% to 8%, by weight, relative to the total weight of the composition, of a foaming agent. The foaming agent (also known as a blowing agent) may be a chemical or physical agent. It is preferably a chemical agent such as for example azodicarbonamide, dinitrosopentamethylenetetramine, p-toluenesulfonyl hydrazide, p,p′-oxybis(benzenesulfonyl hydrazide), or combinations of two or more of these, or mixtures based on citric acid and sodium hydrogen carbonate (NaHCO₃) (such as the product of the Hydrocerol® range from Clariant). It may also be a physical agent, for instance dinitrogen or carbon dioxide, or a hydrocarbon, chlorofluorocarbon, hydr chlorocarbon, hydrofluorocarbon or hydrochlorofluorocarbon (saturated or unsaturated). For example, butane or pentane may be used. To adapt the expansion-decomposition temperature and the foaming processes, a foaming agent may be a mixture of (physical and/or chemical) foaming agents or of foaming agents and an activator.

According to one embodiment, when a chemical foaming agent is used, the foam additionally comprises from 0.1% to 10%, or preferably from 0.1% to 5% of an activator of the foaming agent. An activator may be one or more metal oxides, metal salts or organometallic complexes, or combinations of two or more of these. Examples include ZnO, zinc stearate, MgO, or combinations of two or more thereof.

Additives

The composition may comprise from 0.1% to 20%, preferably from 0.1% to 15%, or from 0.1% to 12%, or from 0.1% to 10%, by weight, relative to the total weight of the composition, of additives.

The additives are typically customary additives used in foams which contribute to improving the properties of the foams and/or the foaming process.

Typically, the additives may be a pigment (TiO₂ and other compatible coloured pigments), dyes, an adhesion promoter (for improving the adhesion of the expanded foam to other materials), organic or inorganic filers (for example, calcium carbonate, barium sulfate and/or silicon oxide), reinforcing agent, plasticizers, nucleating agent (in pure form or in concentrated form, for example, CaCO₃, ZnO, SiO₂, or combinations of two or more of these, rubber (for improving the rubber elasticity, such as natural rubber, SBR, polybutadiene and/or ethylene propylene terpolymer), stabilizers, antioxidants, UV absorbers, flame retardants, carbon black, carbon nanotubes, mould-release agent, impact-resistant agents and additives for improving processability (processing aids), for example stearic acid). The antioxidants (modifying the organoleptic properties such as reducing odour or taste) may include phenolic antioxidants such as IRGANOX from Ciba Geigy Inc. (Tarrytown, N.Y.).

Process

The foam of the invention can be obtained from the composition as defined above by a certain number of processes, such as compression moulding, injection moulding or hybrids of extrusion and moulding.

The invention also relates to a process for preparing a foam, comprising:
(i) a step of providing a mixture comprising:
   a copolymer (a),
   a copolymer (b),
   a crosslinking agent, preferably a peroxide,
   a foaming agent, preferably a chemical foaming agent, and
   optionally a polyolefin (c), a thermoplastic electromeric polymer (d), and at least one additive;
(ii) a step of shaping the mixture by injection moulding, compression/moulding or extrusion;
(ii) a step of foaming the mixture.

The above steps can be carried out separately or simultaneously.

According to one embodiment, steps (i)+(ii), (ii)+(iii) or (i)+(ii)+(iii) are carried out simultaneously.

The steps of the preparation process can be performed in the same item of equipment, for example in a mixer or an extruder.

According to one embodiment, step (i) is carried out by mixing, in the molten state:
from 30% to 99.9% by weight of the copolymer (a);
from 0.1% to 50%, preferably from 0.1% to 40%, by weight of the copolymer (b);
from 0% to 50% by weight of the polyolefin (c) and/or the thermoplastic elastomeric polymer (d);
from 0.1% to 20% by weight of at least one additive;
0.01% to 2% by weight of the crosslinking agent, preferably a peroxide;
from 0.5% to 10% by weight of the foaming agent, preferably a chemical foaming agent,
   the total amounting to 100% by weight of the mixture.

According to another variant, the foaming agent is introduced during and/or alter step (i). The amount of the foaming agent introduced into the process is typically 75 from 0.5% to 10% by weight relative to the total weight of the mixture.

A homogeneous molten mixture is obtained at the end of the mixing step.

The compounds may be mixed by any means known to a person skilled in the art, for example using a Banbury mixer, intensive mixers, a rollmixer, an open mil, or an extruder.

The time, temperature and shear rate can be regulated to ensure optimum dispersion without premature crosslinking or foaming. A high mixing temperature c lead to premature crosslinking and foaming as a result of decomposition of the crosslinking agents, for example peroxides, and of the foaming agents. The compounds may form a homogeneous mixture when they are mixed at temperatures of around 60° C. to around 200° C., or from 80° C. to 180° C., or from 70° C. to 150° C. or from 80° C. to 130° C. The upper temperature limit for satisfactory operation can depend on the initial decomposition temperatures of the crosslinking agents and of the foaming agents that are used.

The (co)polymer may be mixed in the molten state before being mixed with other compounds. For example, the polymers may be mixed in the molten state in an extruder at a temperature ranging up to around 250° C. to enable a good potential mixing. The resulting mixture may then be mixed with the other compounds described above.

After mixing, shaping may be carried out, by injection moulding, compression in a mould or extrusion.

The mixture may be shaped in the form of sheets, pellets or granules, with the appropriate dimensions for foaming. Roll mixers are frequently used to produce sheets. An extruder can be used to shape the composition in the form of pellets or granules.

The foaming step can be carried out in a compression mould at a temperature and for a time which make it possible to achieve decomposition of the crosslinking agents and of the foaming agents. The foaming step can be carried out during injection of the composition into the mould, and/or by opening the mould. The temperature and time applied during the faming step can be easily regulated by a person skilled in the art to optimize foaming of the EVA and/or a copolymer of ethylene and of alkyl (meth)acrylate. Alternatively, the foaming step can be carried out directly on exiting an extrusion. The resulting foam may furthermore be shaped to the dimensions of the finished product by any means known in the art, such as by thermoforming and compression moulding.

It has been observed that the PEBA copolymer does not contribute to the crosslinking of the foam under these conditions but that, unexpectedly, its presence does not hinder the formation of the crosslinked foam of the EVA and/or a copolymer of ethylene and of alkyl (meth)acrylate and further provides particularly interesting properties to the foam as indicated above.

Foam and use Thereof

The foam according to the invention preferably has a density of less than or equal to 800 kg/m³, more preferentially less than or equal to 600 kg/m³, even more preferentially less than or equal to 400 kg/m³ or to 300 kg/m³ and particularly preferably less than or equal to 200 kg/m³. It may, for example, have a density of from 25 to 800 kg/m³ and more particularly preferably from 50 to 600 kg/m³, or from 50 to 200 kg/m³. The density may be controlled by adapting the parameters of the production process.

Preferably, this foam has a rebound resilience, according to the standard ISO 8307: 2007, of greater than or equal to 50%, preferably greater than or equal to 55%. Generally, the resilience of the foam of the invention is less than 80%, or is 75%, or 70%.

Preferably, this foam has a compression set after 30 minutes, according to the standard ISO 7214:2012, of less than or equal to 60%, and preferably less than or equal to 55%, or else less than or equal to 50%.

Preferably, this foam also has excellent properties in terms of fatigue strength and dampening.

The foam of the present invention has improved resilience while still retaining appropriate stiffness and lightness, good dimensional stability and good abrasion resistance, which is particularly suitable for application in shoes.

The foam of the present invention provides better adhesion to the other elements in order to facilitate complex assembly. This is because EVA foams are substrates that are not very polar and that adhere weekly to the other elements of the shoe, making the assembly steps complex. This is particularly interesting in the context of a shoe which is often in multilayer form.

The foam according to the invention may be used for producing sports articles, such as sports shoe soles, ski shoes, midsoles, insoles, or else functional sole components, in the form of inserts in the various parts of the sole (for example the heel or the arch), or else shoe upper components in the form of reinforcements or inserts into the structure of the shoe upper, or in the form of protections.

It may also be used for producing balls, sports gloves (for example football gloves), golf ball components, rackets, protective elements (jackets, interior elements of helmets, shells, etc.).

Typically, these articles may be produced by injection moulding or by injection moulding followed by compression moulding.

The foam according to the invention has advantageous anti-impact, anti-vibration and anti-noise properties, combined with haptic properties suitable for equipment goods. It may thus also be used for producing railway rail pads, or various parts in the motor vehicle industry, in transport, in electrical and electronic equipment, in construction or in the manufacturing industry.

### EXAMPLES

The examples were carried out with the mixtures described in Table 1.

The EVA copolymer used is a product sold by SK Functional Polymer Evatane® 28-05, an EVA copolymer with a vinyl acetate content of 28% by weight and a melt flow index of 5 g/10 minutes.

The branched copolymer of Example 1 and of Comparative Example 2 comprises PA 6112 blocks of number-average molar mass 1000 g/mol and PTMG blocks of number-average molar mass 1000 g/mol. The branching is performed by adding a polyol residue of trimethylolpropane type comprising TO three hydroxyl groups in an amount of 0.02% by weight relative to the total weight of the PEBA copolymer, according to the protocol as described in document EP1783156 A1. The copolymer thus branched has a weight-average molar mass Mw of 134 000 g/mol, an Mw/Mn molar mass ratio of 2.9 and an Mz/Mw molar mass ratio of 2.2. The compounds were mixed at 100° C. for 10 minutes in a mixer to form a molten mass. The mixtures were then shaped (in the form of sheets) at 95° C. using a roll mixer. The sheets obtained were then tuned by compression/moulding in a press (Darragon) for 20 minutes at 160° C.

The mechanical tests performed on the foams are as follows:
density measurement (kg/m³), according to the standard ISO 845;
hardness (Asker C),
shrinkage (%) after 1 h at 70° C.,
bell rebound resilience (%): according to the standard ISO 8307 (a 16.8 g steel ball 16 mm in diameter is dropped from a height of 500 mm onto a foam sample; the rebound resilience then corresponds to the percentage of energy retuned to the ball, or percentage of the initial height reached by the ball on rebound) and
compression set (comp. set, %): a measurement is carried out consisting in compressing a sample to a given degree of deformation and for a given time, then in releasing the stress, and in noting the residual deformation alter a recovery time; the measurement is adapted from the standard ISO 7214, with a deformation of 50%, a hold time of 6 h, a temperature of 50° C.

TABLE 1

| | | Comparative | Comparative | Exam- |
|---|---|---|---|---|
| | Compounds | Example 1 | Example 2 | ple 1 |
| Polymer | EVA 28-05 | 100 | 0 | 80 |
| matrix (%} | PEBA | 0 | 100 | 20 |

| | | |
|---|---|---|
| Additives | ZnO | 2 |
| (PHR) | TiO₂ | 1 |
| | Stearic acid | 0.8 |
| | (processing acid) | |
| Crosslinking | Luperox ® DCP | 0.8 |
| agent (PHR) | (dicumyl peroxide) | |
| | (commercial product | |
| | froms Arkema) | |
| Foaming | Cellcom | 7 |
| agent | JTR-M50M2 | |
| (PHR) | (azodicarbonamide) | |
| | (commercial | |
| | product from | |
| | Kum Yang) | |

| | | | |
|---|---|---|---|
| Foamability | ∘ | x | ∘ |

PHR = parts per hundred of resin (unit of measurement used in formulation denoting the number of parts of a constituent per hundred parts of polymer matrix by mass)

The parameter “foamability” appearing in Table 1 denotes the capacity of the composition to repeatedly form a quality foam. It is determined according to the following criteria:
∘: good expansion of the foam in three spatial directions, dimensions of the foam preserved after cooling, fine and homogeneous call structure,
×: weak expansion of the foam (or none at all), dimensions of the foam lost after cooling due to collapse and/or coarse and heterogeneous cell structure.

TABLE 2

| | | Comparative | |
|---|---|---|---|
| | | Example 1 | Example 1 |
| Rebound resilience | % | 50 | 54 |
| Density | kg/m³ | 210 | 181 |
| Hardness | Asker C | 44 | 41 |
| Comp. set | % (50%, 6 h) | 55 | 54 |
| Shrinkage | % (70° C. 1 h) | 5 | 2.3 |

The crosslinked EVA foam comprising 20% by weight of branched PEBA in the polymer matrix (Example 1) was formed homogeneously and stably. The results of the tests are repeatable (3 foams produced over 3 tests). Evaluation of the mechanical performance qualities of the foams reveals an increase in the rebound resilience of 50% vs. 54%, a reduction in t density (210 vs. 181 kg/m³) without deterioration in the hardness or compression set, and also a reduction in shrinkage after annealing for 1 h at 70° C. Comparative Example 2 shows that it is not possible to obtain a quality foam from branched PEBA alone under similar conditions.

1. Composition comprising:
a copolymer (a) chosen from an ethylene-vinyl acetate (EVA) copolymer, a copolymer of ethylene and of alkyl (meth)acrylate and/or mixtures thereof,
a branched copolymer (b) containing polyamide blocks and polyether blocks, the number-average functionality (Efn) of which is greater than 2,
optionally a polyolefin (c) and/or a thermoplastic elastomeric polymer (d),
a crosslinking agent.

2. Composition according to claim 1, comprising
from 30% to 99.9%, typically from 50% to 99.9% by weight of a copolymer (a) chosen from an ethylene-vinyl acetate (EVA) copolymer, a copolymer of ethylene and of alkyl (meth)acrylate and/or mixtures thereof,
from 0.1% to 40% by weight of a branched copolymer (b) containing polyamide blocks and polyether blocks, the number-average functionality (Efn) of which is greater than 2,
from 0% to 50% by weight, relative to the total weight of the composition, of a polyolefin (c) and/or a thermoplastic elastomeric polymer (d),
from 0.01% to 2% by weight of a crosslinking agent, the total amounting to 100% by weight.

3. Composition according to claim 1, wherein the branching of the copolymer (b) is performed by a polyol residue binding polyamide blocks of the copolymer (b), said polyol being a polyol comprising at least three hydroxyl groups.

4. Composition according to claim 1, wherein the branching of the copolymer (b) is performed by a polyepoxide compound residue binding polyamide blocks of the copolymer (b), said polyepoxide compound being a polyepoxide compound comprising at least three epoxide functions.

5. Composition according to claim 1, wherein the polyamide blocks of the copolymer (b) comprise polyamide blocks chosen from PA 6, PA 11, PA 12, PA 5.4, PA 5.9, PA 5.10, PA 5.12, PA 5.13, PA 5.14, PA 5.16, PA 5.18, PA 5.36, PA 6.4, PA 6.9, PA 6.10, PA 6.12, PA 6.13, PA 6.14, PA 6.16, PA 6.18, PA 6.36, PA 10.4, PA 10.9, PA 10.10, PA 10.12, PA 10.13, PA 10.14, PA 10.16, PA 10.18, PA 10.36, PA 10.T, PA 12.4, PA 12.9, PA 12.10, PA 12.12, PA 12.13, PA 12.14, PA 12.16, PA 12.18, PA 12.36, PA 12.T, PA6/12, PA11/12, PA11/10.10, or mixtures or copolymers thereof.

6. Composition according to claim 1, wherein the polyether blocks of the copolymer (b) are chosen from PEG blocks, and/or PPG blocks, and/or PO3G (polytrimethylene glycol) blocks and/or PTMG blocks.

7. Composition according to claim 1, wherein the weight-average molar mass (Mw) of the copolymer (b) is greater than 80 000 g/mol.

8. Composition according to claim 1, wherein the Mw/Mn molar mass ratio is greater than or equal to 2.2 and/or the Mz/Mw molar mass ratio is greater than or equal to 1.8.

9. Composition according to claim 1, wherein the polyolefin (c) is a functionalized polyolefin (c1).

10. Composition according to claim 1, wherein the thermoplastic elastomeric polymer (d) is chosen from a copolymer containing polyester blocks and polyether blocks, a thermoplastic polyurethane, an olefinic thermoplastic elastomer or an olefinic block copolymer, a styrene-diene block copolymer, and/or mixtures thereof.

11. Foam of a composition according to claim 1.

12. Process for preparing a composition according to claim 1, comprising:
(i) a step of providing a mixture comprising:
a copolymer (a),
a copolymer (b),
a crosslinking agent,
optionally a polyolefin (c), a thermoplastic elastomeric polymer (d), and at least one additive;
(ii) a step of shaping the mixture by injection moulding, compression/moulding or extrusion.

13. Process for preparing a foam according to claim 11, comprising:
(i) a step of providing a mixture comprising:
a copolymer (a),
a copolymer (b),
a crosslinking agent,
a foaming agent,
optionally a polyolefin (c), a thermoplastic elastomeric polymer (d), and at least one additive;
(ii) a step of shaping the mixture by injection moulding, compression/moulding or extrusion;
(iii) a step of foaming the mixture.

14. Process according to claim 13, wherein step (i) is carried out by mixing, in the molten state:
from 30% to 99.9% by weight of the copolymer (a);
from 0.1% to 50% by weight of the copolymer (b);
from 0% to 50% by weight of the polyolefin (c) and/or the thermoplastic elastomeric polymer (d);
from 0% to 20% by weight of at least one additive;
0.01% to 2% by weight of the crosslinking agent;
from 0.5% to 10% by weight of the foaming agent,
the total amounting to 100% by weight of the mixture.

15. Composition or foam capable of being obtained according to the process of claim 12.

16. Article, comprising at least one element consisting of a composition or of a foam according to claim 1.

17. Article according to claim 16, which is chosen from shoe soles, large or small balls, gloves, personal protective equipment, rail pads, motor vehicle parts, construction parts and electrical and electronic equipment parts.
